(19) United States
(12) Patent Application Publication
(10) Pub. No.: US 2007/0174455 A1
(43) Pub. Date: Jul. 26, 2007

(54) Image processing apparatus which executes operations by receiving control information from external devices such as personal computers, interface information disclosing program embodied in a computer readable recording medium, and interface information disclosing method

(75) Inventor: Tetsuya Sugimoto, Muko-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/541,701

(22) Filed: Oct. 3, 2006

(30) Foreign Application Priority Data
Jan. 23, 2006 (JP) 2006-013900

(51) Int. Cl. G06F 15/173

(52) U.S. Cl. 709/225

(57) ABSTRACT

To improve a processing efficiency of operations executed in response to external controls, an MFP includes an operation processing element capable of executing multiple types of operations, an interface (I/F) information table storage element which stores an I/F information table where each piece of I/F information of multiple pieces of the I/F information is correlated with one of multiple access levels, each piece of the I/F information including a control command to control the operation processing element, a request acquiring element which receives a request to acquire a piece of the I/F information, a level determining element which determines an access level of the acquisition request, an I/F information acquiring element which acquires a piece of the I/F information correlated with the determined access level in accordance with a level definition table, and an I/F information transmitting element which transmits the I/F information.

This application is based on Japanese Patent Application No. 2006-013900 filed with Japan Patent Office on Jan. 23, 2006, the entire content of which is hereby incorporated by reference.

### BACKGROUND OF THE INVENTION

1. Field of the Invention

The present invention relates to an image processing apparatus, an interface information disclosing program embodied in a computer readable recording medium, and an interface information disclosing method. More particularly, the present invention relates to an image processing apparatus which executes operations in response to control information received from external personal computers and the like, a program embodied in a computer readable recording medium and executed in the image processing apparatus for disclosing interface information, and a method for disclosing interface information.

2. Description of the Related Art

Currently, multiple function peripherals (hereinafter referred to as “MPFs”) ensure security by giving different permissions to execute operations for individual users. For example, a user who controls a MFP is permitted to set basic information such as user registration, but other users who are not the administrator of the MFP are not permitted to execute such settings. In addition, recent MFPs are connected to networks so that predetermined operations can be executed from personal computers (hereinafter referred to as “PCs”). The administrator can set basic information such as user registration in the MFP from his/her PC, but other users are not allowed to do that.

United States Patent Application Publication No. US2002/0099837A1 discloses an information processing method wherein an operation request from a process or an operating system (OS) for computer resources, such as files, networks, storage devices, display screens, external devices, and so on which are managed by the OS, is trapped before accessing to any computer resources. The presence of an access right for the computer resource designated by the trapped operation request is determined, and if the access right is present, the operation request is transferred to the OS as requested and the result of the access is returned to the requesting process. Conversely, if no access right is found, the operation request is rejected, or otherwise permitted by charging a payment depending on the contents of the computer resources.

In this method, however, if no access right is found for the operation request received from a PC connected to a network, an error procedure such as notifying the rejection of the operation request to the PC is required. This also increases the traffic of data flowing through the network and wastes the network resources. On the other hand, the presence of the access right must be checked on the PC when the operation request is sent, which forces a complicated task on the user of the PC. It is also likely that malicious users may modify the operation request so that it can be accepted without any access right, which compromises security.

### SUMMARY OF THE INVENTION

The present invention is directed to overcoming the problem set forth above and one object of the present invention is to provide an image processing apparatus capable of processing externally controlled operations with an improved processing efficiency, an interface information disclosing program embodied in a computer readable recording medium, and a method for disclosing interface information.

Another object of the present invention is to provide an image processing apparatus with an enhanced security, an interface information disclosing program embodied in a computer readable recording medium, and a method for disclosing interface information.

To achieve the above objects, in accordance with one aspect of the present invention, an image processing apparatus includes an operation processing element capable of executing multiple types of operations, an interface (I/F) information table storage element for storing an I/F information table where each piece of I/F information of multiple pieces of the I/F information is correlated with one of multiple access levels, each piece of I/F information including control information to control the operation processing element, an acquisition request receiving element for receiving a request to acquire a piece of the I/F information, a level acquiring element for acquiring an access level of the acquisition request, and an I/F information transmitting element for transmitting the I/F information correlated with the acquired access level in accordance in the I/F information table.

Preferably, one of the multiple types of operations is defined for each control command of the multiple control commands, and when one of the multiple control commands is received, the operation processing element executes a particular operation of the multiple types of operations identified by the received control command. Each of the multiple pieces of the I/F information includes at least one control command of the multiple control commands.

Preferably, the I/F information includes parameters corresponding to each command of the multiple control commands, and when the operation processing element receives one control command of the multiple control commands together with a certain parameter corresponding to the received control command, the operation processing element executes a particular operation of the multiple types of operations identified by the received control command in accordance with the received parameter. Each of the multiple pieces of the I/F information includes a parameter corresponding to each command of the multiple control commands.

In accordance with another aspect of the present invention, an image processing apparatus includes an operation processing element capable of executing multiple types of operations, an acquisition request receiving element for receiving a request for acquiring interface (I/F) information which includes control information for controlling the operation processing element, a level acquiring element for acquiring an access level of the acquisition request, an I/F information generating element for generating the I/F information corresponding to the acquired access level, and an I/F information transmitting element for transmitting the generated I/F information.

In accordance with a further aspect of the present invention, an image processing apparatus includes an operation processing element which executes a particular operation identified by one control command of multiple control commands when the one control command is received, an execution feasibility table storage element for storing an execution feasibility table where the feasibility of executing each control command of the multiple control commands is correlated with identification (ID) information which identifies a user or a device, an authentication element for authenticating the user or the device by acquiring the ID information, an interface (I/F) information generating element for generating the I/F information by choosing an executable control command correlated with the ID information in the execution feasibility table, and an I/F information transmitting element for transmitting the generated I/F information.

In accordance with a still further aspect of the present invention, an I/F information disclosing program embodied in a computer readable recording medium is executed in an image processing apparatus capable of executing multiple types of operations. The image processing apparatus includes an I/F information table storage element for storing an I/F information table where each piece of I/F information of multiple pieces of the I/F information is correlated with one of a plurality of access levels, each piece of the multiple I/F information including control information to control the operation processing element. The program causes the image processing apparatus to execute the steps of receiving an acquisition request to acquire one piece of the multiple pieces of the I/F information, acquiring an access level of the acquisition request, and transmitting the I/F information correlated with the acquired access level in the I/F information table.

In accordance with a still further aspect of the present invention, an I/F information disclosing program embodied in a computer readable recording medium is executed in an image processing apparatus capable of executing multiple types of operations. The program causes the image processing apparatus to execute the steps of receiving an acquisition request for acquiring the I/F information including control information to control the image processing apparatus, acquiring an access level of the acquisition request, generating the I/F information corresponding to the acquired access level, and transmitting the generated I/F information.

In accordance with a still further aspect of the present invention, an I/F information disclosing program embodied in a computer readable recording medium is executed in an image processing apparatus which executes a particular operation identified by one control command of multiple control commands when the one control command is received, and the image processing apparatus includes an execution feasibility table storage element for storing an execution feasibility table where the feasibility of executing each command of the multiple control commands is correlated with identification information which identifies a user or a device. The program causes the image processing apparatus to execute the steps of authenticating the user or the device by acquiring the identification information, generating interface (I/F) information for the ID information acquired in the authenticating step by choosing an executable control command correlated with the ID information in the execution feasibility table, and transmitting the generated I/F information.

In accordance with a still further aspect of the present invention, a method for disclosing I/F information is executed in an image processing apparatus capable of executing multiple types of operations, and the image processing apparatus includes an I/F information table storage element for storing an I/F information table where each piece of I/F information of multiple pieces of the I/F information is correlated with one of a plurality of access levels, and each piece of interface information includes a control command to control the operation processing element. The method causes the image processing apparatus to execute the steps of receiving a request to acquire a piece of the I/F information, acquiring an access level of the acquisition request, and transmitting the acquired I/F information correlated with the acquired access level in the I/F information table.

In accordance with a still further aspect of the present invention, a method for disclosing I/F information is executed in an image processing apparatus capable of executing multiple types of operations. The method causes the image processing apparatus to execute the steps of receiving a request for acquiring the I/F information including control information to control the image processing apparatus, acquiring an access level of the acquisition request, and generating the I/F information corresponding to the acquired access level, and transmitting the generated I/F information.

In accordance with a still further aspect of the present invention, a method for disclosing I/F information is executed in an image processing apparatus which executes a particular operation in response to one control command of multiple control commands when the one control command is received, and the image processing apparatus includes an execution feasibility table storage element for storing an execution feasibility table where the feasibility of executing each command of the multiple control commands is correlated with identification information which identifies a user or a device. The method causes the image processing apparatus to execute the steps of authenticating the user or the device by acquiring the identification information, generating the I/F information for the ID information acquired in the authenticating step by choosing an executable control command correlated with the identification information in the execution feasibility table, and transmitting the generated I/F information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall schematic diagram illustrating a printing system according to an embodiment of the present invention;

FIG. 2 is a block diagram illustrating an example of the hardware structure of a MFP;

FIG. 3 is a functional block diagram illustrating an overall function of the CPU in the MFP and a list of information stored in the HDD;

FIG. 4 is an example of a table of control commands;

FIG. 5 is an example of an execution feasibility table;

FIG. 6 is an example of a level definition table;

FIG. 7 is an example of an interface information table;

FIG. 8 is a flow chart illustrating an example of a first I/F information disclosing procedure;

FIG. 9 is a flow chart illustrating an example of a control command execution procedure;

FIG. 10 is a functional block diagram illustrating an overall function of the CPU in the MFP and a list of information stored in the HDD in accordance with a first modified embodiment of the present invention;

FIG. 11 is an example of a selection table;

FIG. 12 is a flow chart illustrating another example of a second I/F information disclosing procedure;

FIG. 13 a functional block diagram illustrating an overall function of the CPU in the MFP and a list of information stored in the HDD in accordance with a second modified embodiment of the present invention; and

FIG. 14 is a flow chart illustrating another example of a third I/F information disclosing procedure.

### DESCRIPTION OF THE PREFERRED EMBODIMENTS

In the following, an embodiment of the present invention will be described with reference to the figures. In the following description, the same parts will be denoted with the same reference characters. Their designations and functions are also the same. Therefore, the detailed description thereof will not be repeated.

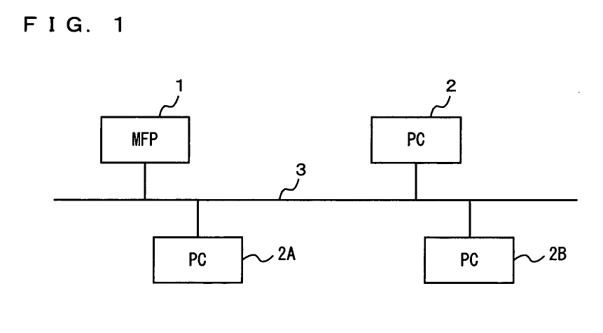

Referring firstly to FIG. 1, there is shown an overall schematic diagram of a printing system according to an embodiment of the present invention. In FIG. 1, a printing system includes a MFP 1 and PCs 2, 2A and 2B which are connected to one another via a network 3. The network 3 is a local network (LAN) which may be implemented in a wired or wireless configuration. Alternatively, the network 3 may be formed of a wide area network (WAN), a public switched telephone network (PSTN), or the Internet. Connected as such, the MFP 1 can communicate with the PCs 2, 2A and 2B connected to one another via the network 3, and executes operations in response to control commands transferred from the PC 2, 2A and 2B, respectively. For example, if one of the PC 2, 2A and 2B transmits a print command and print data, the MFP 1 forms an image of the print data in response to the received print command. It is noted that in the present description, the MFP 1 executes operations in response to the control commands transferred from the PC 2, unless otherwise specifically mentioned.

The MFP 1 performs various functions including copying, scanning, facsimile transmission/receiving, printing and data storage. The MFP 1 includes a hard disc drive which functions as a mass storage device to store various kinds of data.

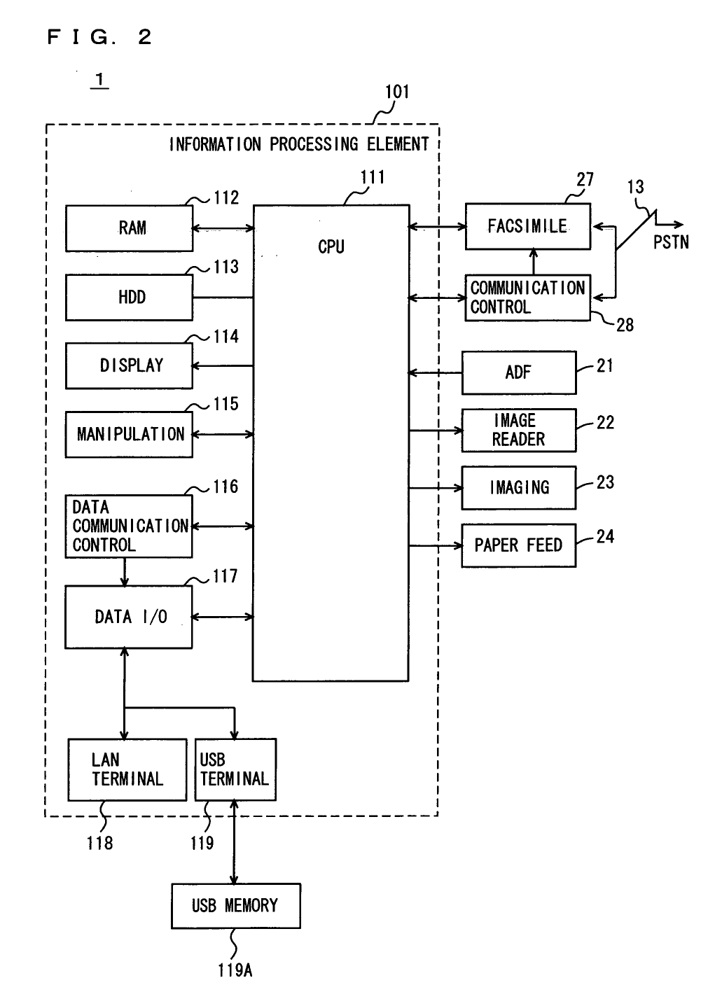

FIG. 2 is a block diagram of an exemplary hardware structure of the MFP. As shown in FIG. 2, the MFP 1 includes an information processing element 101, a facsimile element 27, a communication control element 28, an automatic document feeder (ADF) 21, an image reader element 22, an imaging element 23, and a paper feeder element 24. The information processing element 101 includes a central processing unit (CPU) 111, a random access memory (RAM) 112 which is used as a working area of the CPU 111, a hard disc drive (HDD) 113 which stores data in a nonvolatile manner, a display element 114, a manipulation element 115, a data communication control element 116, and a data input/output (I/O) element 117. The CPU 111 is connected to the data I/O element 117, the data communication control element 116, the manipulation element 115, the display element 114, the HDD 113, and the RAM 112, in order to control the entire information processing element 101. The CPU 111 is also connected to the facsimile element 27, the communication control element 28, the ADF 21, the image reader element 22, the imaging element 23, and the paper feeder element 24, in order to control the entire MFP 1.

The display element 114 is implemented by a display device such as a liquid crystal display (LCD) and an organic electroluminescence display (EL), and displays a menu of instructions or the information of acquired image data toward users. The manipulation element 115 includes a plurality of keys for entering data of various instructions, letters and numerals by manipulating individual keys by users. The manipulation element 115 also includes a touch panel provided on the display element 114. The display element 114 and the manipulation element 115 form the control panel.

The data communication control element 116 is connected to the data I/O element 117. The data communication control element 116 controls the data I/O element 117 in response to an instruction from the CPU 11, and transmits/receives data to and from external devices connected to the data I/O element 117. The data I/O element 117 includes a LAN terminal 118 and a universal serial bus (USB) terminal 119 which are used to provide communication in accordance with a communication protocol such as a transmission control protocol (TCP) or a file transfer protocol (FTP).

When a LAN cable is connected to the LAN terminal in order to connect to the network 3, the data communication control section 116 controls the data I/O element 117 to communicate with the PCs 2, 2A and 2B connected to the network 3 via the LAN terminal 118.

When a certain device is connected to the USB terminal 119, the data communication control element 116 controls the data I/O element 117 to communicate with the connected device to input/output data. A USB memory 119A including a flash memory can be connected to the USB terminal 119. The USB memory 119A previously stores an interface (I/F) information disclosing program which will be described later. The CPU 111 controls the data communication control element 116 to read the I/F information disclosing program from the USB memory 119A, stores the I/F information disclosing program in the RAM 112 and executes it.

The USB memory 119A is one type of recording medium storing the I/F information disclosing program, and other medium capable of bearing the program in a fixed manner, such as a flexible disc, cassette tape, an optical disc, compact disc-read only memory (CD-ROM), magnetic optical disc (MO), mini disc (MD), digital versatile disc (DVD), an IC card (including memory card), an optical card, and a semiconductor memory such as mask ROM, erasable programmable ROM (EPROM), and electronically erasable programmable ROM (EEPROM) may be used. Alternatively, the CPU 111 may download the I/F information disclosing program from a computer such as the PC 2 connected to the network 3 and stores it in the HDD 113, or the PC 2 may write the I/F information disclosing program in the HDD 113. The I/F information disclosing program stored in the HDD 113 is then loaded to the RAM 112 and executed by the CPU 111. In the present embodiment, the term “program” includes not only a program executable directly by the CPU 111, but also other programs such as source-type programs, compressed programs and encrypted programs.

The facsimile element 27 is connected to the PSTN 13 and transmits and/or receives facsimile data to and from the PSTN 13. The facsimile element 27, while storing the received facsimile data in the HDD 113, also provides the data to the imaging element 23 after converting it into print data which is printable in the imaging element 23. In response, the imaging element 23 prints the facsimile data received from the facsimile element 27 on a sheet of recording medium. The facsimile element 27 also converts the data stored in the HDD 113 into facsimile data and transmits it to a FAX machine connected to the PSTN 13.

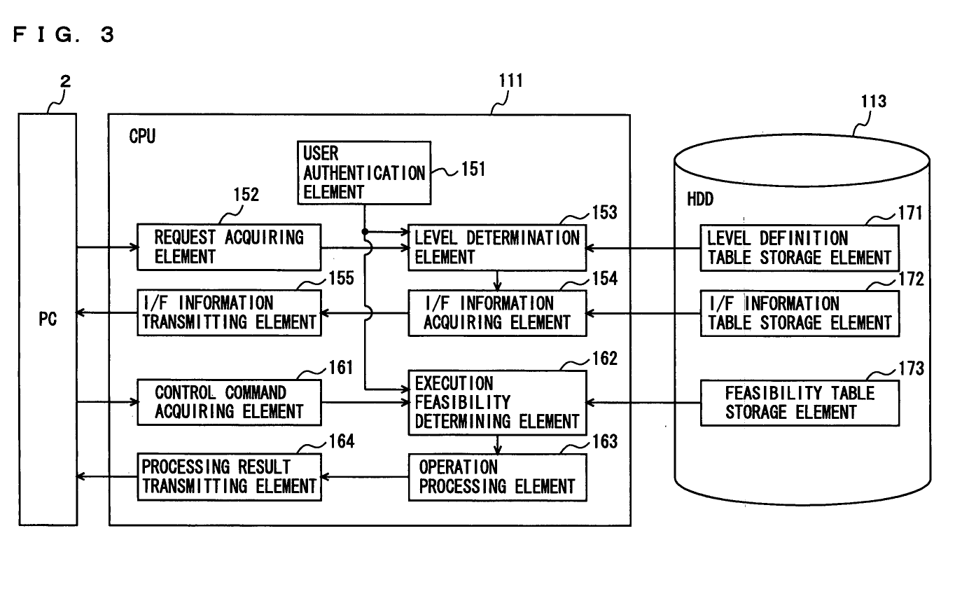

Referring now to FIG. 3, there is shown a functional block diagram illustrating an overall function of the CPU in the MFP and a list of information stored in the HDD. As shown in FIG. 3, the HDD 113 includes a level definition table storage element 171, an I/F information table storage element 172, and an feasibility table storage element 173. The CPU 111 includes a request acquiring element 152 for getting a request to send the I/F information from the PC 2, a user authentication element 151 for authenticating the user who originated the send request at the PC 2, a level determination element 153 for acquiring a previously assigned level to the user who originated the send request, an I/F information acquiring element 154 for acquiring the I/F information corresponding to the determined level, an I/F information transmitting element 155 for returning the acquired I/F information, a control command acquiring element 161 for receiving a control command from the PC 2, an execution feasibility determining element 162 for determining the feasibility of the control command, an operation processing element 163 for executing the operation in response to the control command when it is determined feasible, and a processing result transmitting element 164 for returning the result of the operation to the PC 2.

The user authentication element 151 authenticates the user who operates the PC 2. In the present embodiment, the data authentication using passwords is described. Alternatively, the authentication data may be formed of vital information (biometrics) such as fingerprints, vein patterns, iris patterns, voiceprints, and so on. The user authentication element 151 authenticates the user based on the user identification (ID) information and the user authentication data transmitted from the PC 2 and, when the authentication succeeds, provides the authenticated user ID information to the level determination element 153 and the execution feasibility determining element 162. The authentication data may be sent from the PC 2 when the user logs in to the MFP 1, or it may be sent with a request to get the I/F information or a control command, which will be described later. If the authentication data is sent from the user when he/she logs in to the MFP 1, the user ID information is provided when the request to get the I/F information or the control command is subsequently sent from the PC 2. In this case, the authentication result from the authentication data received at the log-in period will be valid until the user logs out of the PC 2. On the other hand, if the authentication data is sent with the acquisition request of the I/F information or the control command, the user authentication element 151 executes user authentication every time the request or command is received.

The control command acquiring element 161 acquires the control command from the PC 2. When the control command is received from the PC 2, the data communication control element 116 supplies it to the CPU 111. The CPU 111 receives the control command acquired by the data communication control element 116 from the PC 2 and supplies it to the execution feasibility determining element 162.

The execution feasibility determining element 162 receives the user ID information from the user authentication element 151 and the control command from the control command acquiring element 161. The execution feasibility determining element 162 determines whether or not the control command is executable in accordance with the execution feasibility table stored in the feasibility table storage element 173. When the control command is determined feasible, the execution feasibility determining element 162 supplies the control command to the operation processing element 163. Conversely, if the control command is determined unfeasible, the execution feasibility determining element 162 sends an error message to the PC 2 instead of supplying the control command to the operation processing element 163.

The operation processing element 163 is capable of processing multiple types of operations. One operation among multiple types of operations has been defined for each control command of a plurality of control commands, and when the operation processing element 163 receives the control command, it executes the operation identified by the control command. Some control commands are provided with parameters, and when the control command with parameter is received, the operation processing element 163 executes the operation identified by the control command in accordance with the parameter. The operation processing element 163 executes the operation in response to the control command and provides a processing result to the processing result transmitting element 164 which, in turn, returns the received processing result to the PC 2 that originated the control command.

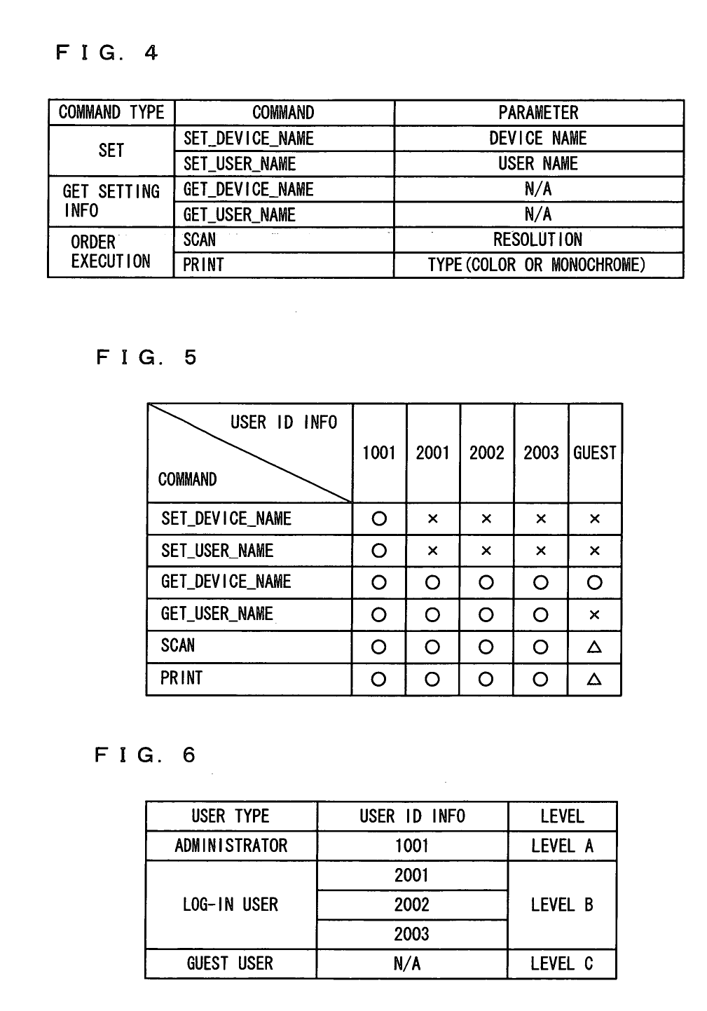

Referring to FIG. 4, there is shown an exemplary table of control commands. As shown in FIG. 4, the control commands are classified into three types, including commands to set, get setting information, and order execution. The set type control commands include a control command (SET_DEVICE_NAME) to set the device name of the MFP 1, and a control command (SET_USER_NAME) to set the user name to be registered in the MFP 1. The name of the device is added as a parameter to the control command (SET_DEVICE_NAME) to set the device name. The name of the user is added as a parameter to the control command (SET_USER_NAME) to set the user name. The get-setting-information type control commands include a control command (GET_DEVICE_NAME) to get the device name of the MFP 1, and a control command (GET_USER_NAME) to get the user name registered in the MFP 1. No parameters are added to these commands. The order-execution type control commands include a control command (SCAN) to cause the MFP 1 to read a document, and a control command (PRINT) to cause the MFP 1 to print a document. A parameter to designate a resolution of reading the document is added to the control command (SCAN). A parameter to designate a print type of the document, i.e., color print or monochrome print, is added to the control command (PRINT).

Referring to FIG. 5, there is shown an exemplary execution feasibility table. As shown in FIG. 5, the execution feasibility table defines whether or not each control command of the multiple control commands is executable for each piece of the user ID information. In the table, feasible control commands are marked by a circle (∘), unfeasible control commands are marked by an (X), and conditionally feasible control commands are marked by a triangle (Δ). In the table, the “guest” shown in the user ID information row indicates a guest user who is not authenticated by the user authentication element 151. The guest user is allowed to execute the control command (SCAN), which causes the MFP 1 to read the document, by limiting the resolution of reading the document to not more than 200 dpi. In addition, the guest user is allowed to execute the control command (PRINT), which causes the MFP 1 to print the document, by limiting the print type to monochrome print. It is noted that instead of defining the feasibility of each control commands of multiple control commands for respective user ID information as in the illustrated figure, several user ID information may be collected into a group so that the feasibility of each control command of the multiple control commands is defined for the group of user ID information. Alternatively, instead of using the user ID information, the feasibility of each control command of the multiple control commands may be defined for the device ID information such as IP address or MAC address which identifies the PCs 2, 2A and 2B.

Referring to FIG. 6, there is shown an exemplary level definition table. As shown in FIG. 6, the level definition table storage element 171 stores a level definition table where the user ID information is correlated with previously assigned levels of the users. Each level indicates how far the I/F information should be disclosed. In the level definition table, a plurality of users are classified into several user types and each type of users is correlated with a certain level. In the present embodiment, three types of users are defined, including administrators who have a right to manage the MFP 1, log-in users who are authenticated and allowed to log-in, and guest users who are not permitted to log-in because the user authentication failed. The administrator type of users are correlated with the highest level A, the log-in type users are correlated with the middle level B, and the guest type users are correlated with the bottom level C. It is noted that instead of correlating the user types with the levels indicating the extent to disclose the I/F information as shown in this figure, the user types may be correlated with the information to identify the I/F information to be disclosed. Further, although three types of users have been defined in the present embodiment, it is sufficient to provide more than one type of users. For example, the users may be divided into several groups and each group may be assigned to a particular level.

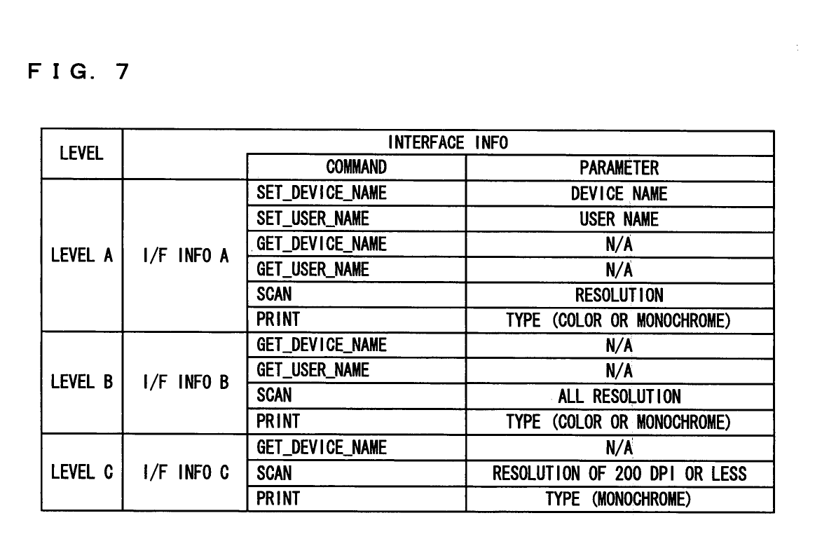

Referring to FIG. 7, there is shown an exemplary I/F information table. As shown in FIG. 7, the I/F information table storage element 172 stores an I/F information table where predetermined I/F information is correlated with each level of multiple levels. In the illustrated I/F information table, an I/F information A is correlated with level A, an I/F information B is correlated with level B, and an I/F information C is correlated with level C. The I/F information A correlated with the level A includes all types of control commands and parameters. The I/F information B correlated with the level B includes all control commands and parameters of the get-setting-information type and the order-execution type, other than the set type control commands. The I/F information C correlated with the level C includes the control command to get device name of the get-setting-information type control commands, and all control commands of the order-execution type. Some parameters are excluded from the commands to order execution in the I/F information C, in order to limit the range of parameters. Specifically, the parameter correlated with the command (SCAN) to order scanning is limited to the scanning resolution not more than 200 dpi, while the parameter correlated with the command (PRINT) to order printing is limited to only the monochrome type print. In the I/F information table, each level involves the control commands and parameters that are given permission to execute from the execution feasibility table in accordance with the user ID information of each level, and other control commands and parameters that are not allowed to execute by the execution feasibility table are excluded.

Referring back to FIG. 3, the request acquiring element 152 acquires a request to send the I/F information from the PC 2. The data communication control element 116, when it receives the request to send the I/F information from the PC 2, provides the request to the CPU 111. The CPU 111 receives the send request from the PC 2 via the data communication control element 116 and provides it to the level determination element 153.

The level determination element 153 receives the user I/D information from the user authentication element 151, while it receives the request to send the I/F information from the request acquiring element 152. The level determination element 153 determines the level corresponding to the received user I/D information in accordance with the level definition table stored in the level definition table storage element 171. Once the level is determined, the level determination element 153 provides the determined level to the I/F information acquiring element 154. The I/F information acquiring element 154, in turn, reads the I/F information corresponding to the determined level from the I/F information table stored in the I/F information table storage element 172 and provides the retrieved I/F information to the I/F information transmitting element 155. The I/F information transmitting element 155 generates transmission data by writing it in, for example, the Web Server Description Language (WSDL) and sends the data to the PC 2.

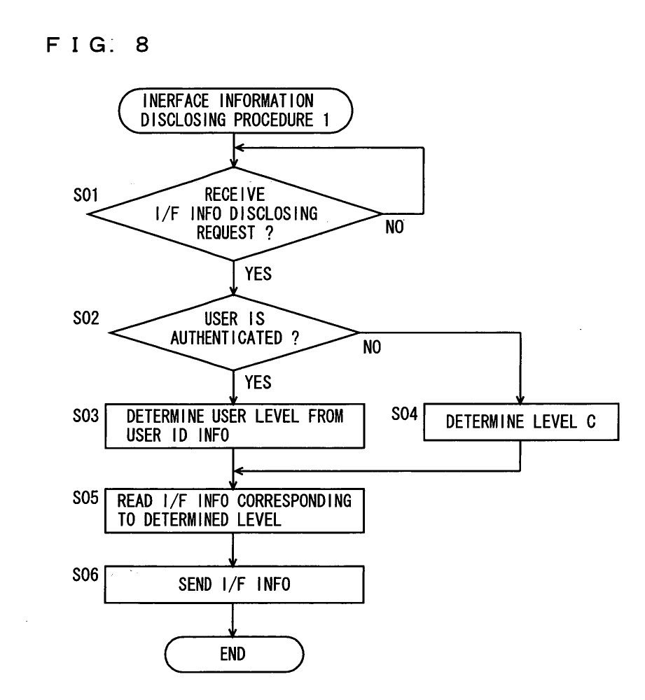

Referring to FIG. 8, there is shown a flow chart illustrating a first exemplary I/F information disclosing procedure. The I/F information disclosing procedure is executed by running an I/F information disclosing program on the CPU 111 of the MFP 1. As shown in FIG. 8, the CPU 11 determines whether or not the send request to request transmission of the I/F information is received from the PC 2 (step S01). If NO is chosen at step S01, the CPU 111 enters the waiting mode until it receives the send request. When the send request is received, the process proceeds to step S02, where it is determined whether or not the requesting user is authenticated. If the user authentication succeeds, the process proceeds to step S03, while the process goes to step S04 if the user authentication failed.

In step S03, the level is determined from the user I/D information of the user who was authenticated in the user authentication process, in accordance with the level definition table stored in the level definition table storage element 171. In the meantime, in step S04, the level C is determined. Because the step S04 is chosen when the user authentication fails, the user is classified as a guest user and determined level C.

In step S05, the I/F information corresponding to the level determined in either step S03 or S04 is read from the I/F information table storage element 172 (step S05), and the retrieved I/F information is sent to the PC 2 that originated the send request in step S01 (step S06).

By reading and transmitting the I/F information corresponding to the level of the user ID information, it is possible to send only the commands and parameters that are permitted for the user to execute.

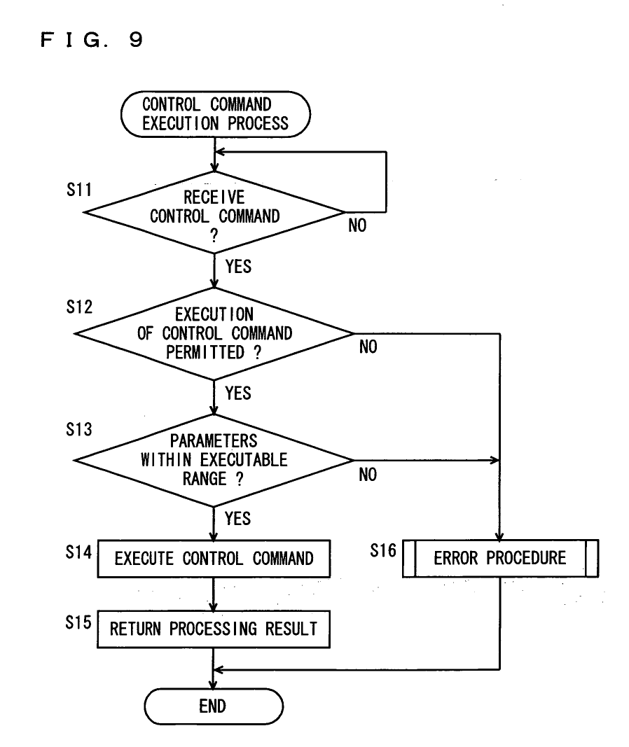

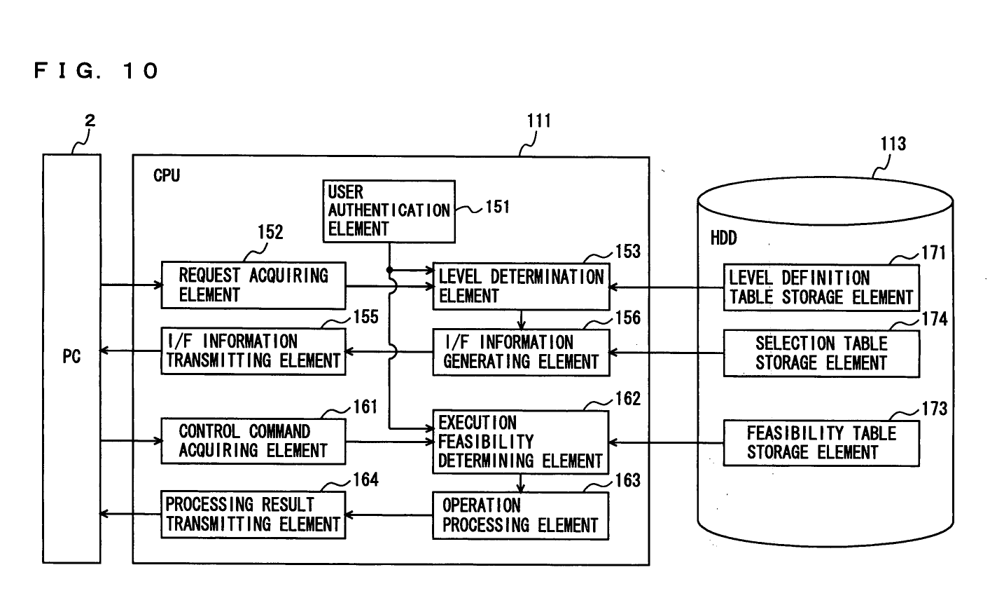

Referring to FIG. 9, there is shown a flow chart illustrating an exemplary control command executing procedure. The control command executing procedure is executed in the CPU 111. As shown in FIG. 9, the CPU 111 determines whether or not the control command is received from the PC 2 (step S11). If NO is chosen at step S11, the CPU 111 enters the waiting mode until it receives the control command. When the control command is received, the process proceeds to step S12. Then, in accordance with the execution feasibility table stored in the feasibility table storage element 173, it is determined whether or not the execution of the control command received in step S11 is permitted (step S12). If the control command is executable, the process proceeds to step S13, otherwise the process goes to step S16.

In step S13, it is determined whether or not the parameter received with the control command in step S11 is within a feasible range, in accordance with the feasibility table stored in the feasibility table storage element 173. If the parameter is within the feasible range, the process proceeds to S14, otherwise the process goes to step S16. In step S14, the operation corresponding to the control command received in step S11 is executed in accordance with the parameter and the processing result is sent to the PC 2 (step S15). In step S16, an error procedure such as sending an error message to the PC 2 is done and the process ends.

As described above, the MFP 1 of the present embodiment stores the I/F information table where each access level of multiple access levels is correlated with one piece of the I/F information of multiple pieces of the I/F information. When the request to acquire one piece of the I/F information of multiple pieces of the I/F information (step S01), the access level of the acquisition request is obtained (steps S03 and S04), the I/F information correlated with the obtained access level is read from the I/F information table (step S05), and the retrieved information is sent (step S06). Because different types of I/F information are sent in response to the access level of the acquisition request, the control commands to be sent also differ depending on the access level. Because the sent control commands have permission to execute granted from the feasibility table stored in the feasibility table storage element 173, it is less likely to receive other control commands than the sent commands. This reduces the number of times the error procedure is executed (step S16), because the error procedure is run only when other control commands than sent commands are received (NO at step S12). This also contributes to security enhancement by preventing the receipt of the control commands other than the control commands having permission to execute.

### First Modified Embodiment

The MFP 1 has been described in the above to have the I/F information table in the I/F information table storage element 172. Alternatively, according to a first modification of the present invention, the MFP 1 includes a selection table storage element 174 for storing a selection table in the HDD 113.

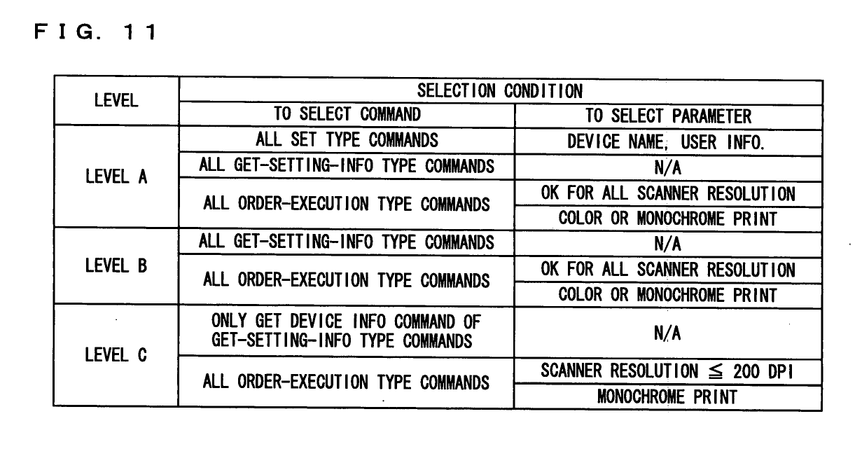

Referring to FIG. 10, there is shown a functional block diagram illustrating an overall function of the CPU in the MFP and a list of information stored in the HDD, according to the first modification of the present invention. FIG. 10 differs from FIG. 3 in that the HDD 113 includes a selection table storage element 174 instead of the I/F information table storage element 172, and the CPU 111 includes an I/F information generating element 156 instead of the I/F information acquiring element 154.

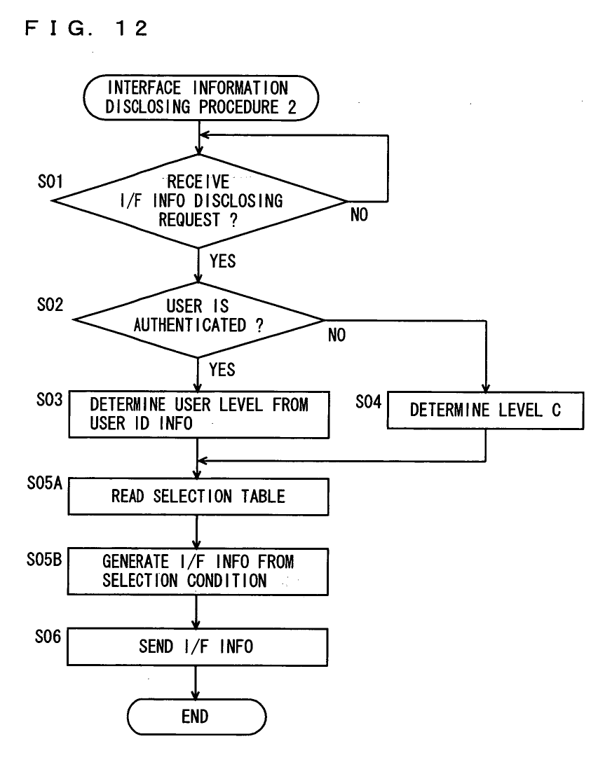

Referring to FIG. 11, there is shown an exemplary selection table. As shown in FIG. 11, the selection table stores a selection conditions which is previously determined for each level of multiple levels. The selection conditions include conditions to select control commands and conditions to select parameters. In the selection table, for the selection conditions corresponding to the level A, the conditions to select control commands designate all control commands of all types including the commands to set, get setting information, and order execution, while the conditions to select parameters designate all parameters within a range capable of being added to those control commands. For the selection conditions corresponding to the level B, the conditions to select control commands designate all control commands of the get-setting-information type and the order-execution type, while the conditions to select parameters designate all parameters within a range capable of being added to those control commands. For the selection conditions corresponding to the level C, the conditions to select control commands designate the control command to get the device information of the get-setting-information type control commands and all control commands of the order-execution type control commands. The selection conditions to select parameters for the level C designate a limited range of parameters corresponding to those limited control commands. Specifically, the control command (SCAN) to order scanning is limited to the scanning resolution not more than 200 dpi, and the control command (PRINT) to order printing is limited to only the monochrome type print. The selection conditions stored in the selection table includes the conditions for each level to select the control commands and parameters having permission to execute granted from the execution feasibility table corresponding to the user ID information for each level. In other words, the control commands and parameters to be selected in accordance with the selection conditions do not include the control commands and parameters having no permission for execution granted based on the execution feasibility table.

The I/F information generating element 156 reads the selection conditions corresponding to each level from the selection table storage element 174, and generates I/F information in accordance with the selection conditions corresponding to each level by selecting the control commands from the multiple control commands together with the parameters that can be added to those control commands. Subsequently, the I/F information generating element 156 provides the generated I/F information to the I/F information transmitting element 155.

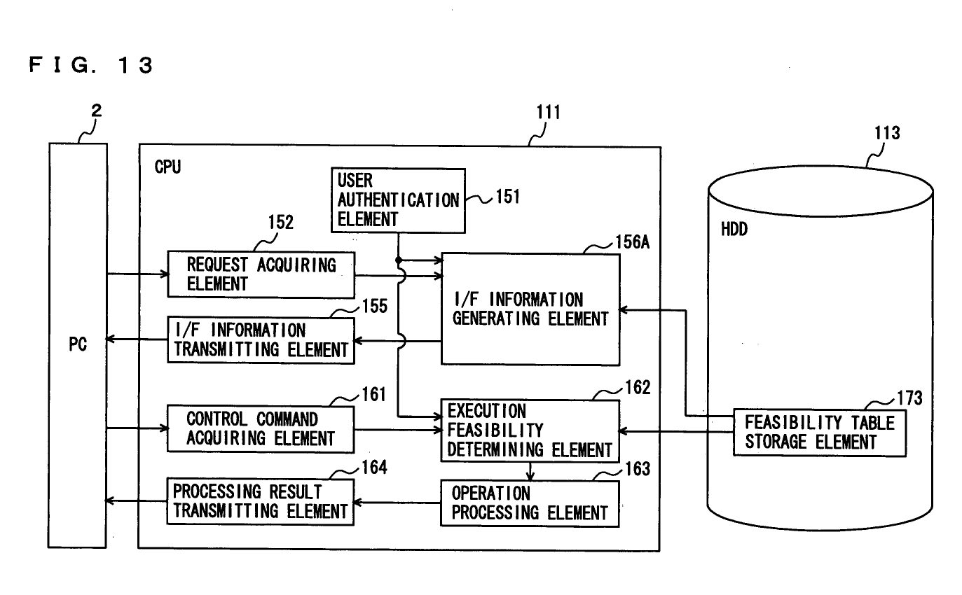

Referring to FIG. 12, there is shown a second exemplary I/F information disclosing procedure. In the I/F information disclosing procedure shown in FIG. 12, the processing at step S05 of FIG. 8 is omitted and replaced by steps S05A and S05B. Other part of the procedure is the same and the description thereof will not be repeated. In step S05A, the CPU 111 reads a selection conditions corresponding to a particular level from the selection table storage element 174. Then, the CPU 111 selects the control commands from the multiple control commands together with the parameters that may be added to the selected commands in accordance with the selection conditions corresponding to the level, and generates the I/F information (step S05B).

As such, the MFP 1 of the first modification of the present invention stores the selection table where selection conditions are correlated to select at least one of the multiple control commands. When the acquisition request to get a piece of the I/F information of the multiple pieces of the I/F information is received (step S01), the MFP 1 gets the access level corresponding to the acquisition request (steps S03 and S04), reads a selection conditions corresponding to the determined level (step S05A), selects commands and parameters in accordance with the selection conditions to generate the I/F information (step S05B), and transmits the generated information (step S06). In this procedure, different types of the I/F information are sent depending on the access level of the acquisition request, so that the control commands to be sent also differ depending on the access level. Because the control commands selected in accordance with the selection conditions have permission for execution granted based on the feasibility table stored in the feasibility table storage element 173, it is possible to reduce the number of times the error procedure is executed (step S16), as it is run only when other control commands than the sent commands sent are received (NO at step S12). This also contributes to security enhancement by preventing the receipt of the control commands other than the control commands having permission to execute. In addition, no storage of the I/F information is needed, so that the memory space of the HDD 113 can be used more efficiently.

### Second Modified Embodiment

According to the second modification of the present invention, the MFP 1 generates the I/F information based on the execution feasibility table stored in the feasibility table storage element 173. The second modification differs from the first modification in the following point.

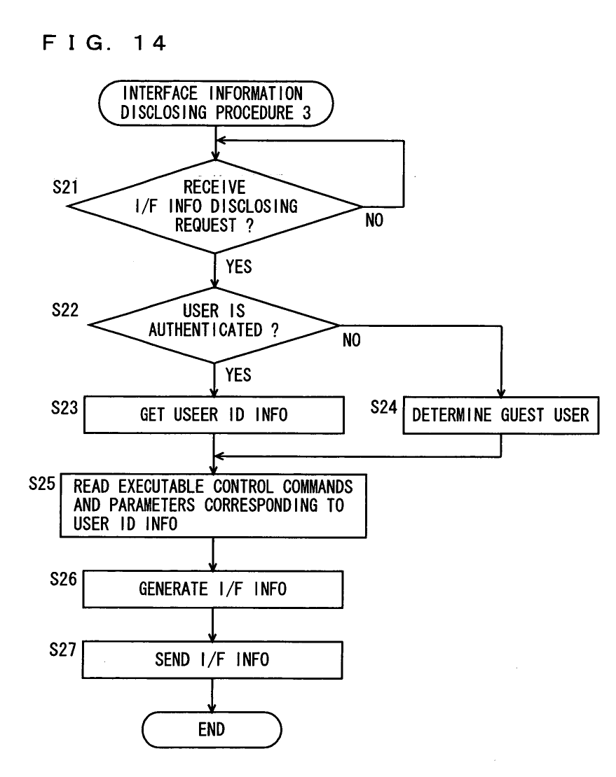

Referring to FIG. 13, there is shown a functional block diagram illustrating an overall function of the CPU in the MFP and the information stored in the HDD according to the second modification of the present invention. FIG. 13 differs from FIG. 10 in that the HDD 113 only includes the feasibility table storage element 173, the CPU 111 excludes the level determination element 153, and the I/F information generating element 156 is changed.

An I/F information generating element 156A receives the user ID information from the user authentication element 151 and also receives the send request to send the I/F information from the request acquisition element 152. When the send request is received, the I/F information generating element 156A reads the control commands to which permission to execute is granted from the feasibility table storage element 173 and a range of parameters corresponding thereto, generates the I/F information including these commands and parameters, and provides the information to the I/F information transmitting element 155.

Referring to FIG. 14, there is shown a third exemplary I/F information disclosing procedure. As shown in FIG. 14, the CPU 111 determines whether or not the send request to request transmission of the I/F information is received from the PC 2 (step S21), and enters the waiting mode until the send request is received if NO is selected at step S21. When the send request is received, the process proceeds to step S22. Then, it is determined whether or not the requesting user is authenticated (step S22) and, if the user is the authenticated user, the process proceeds to S23, otherwise the process goes to step S24. In step S23, the user I/D information of the authenticated user is acquired, while the user I/D information to be supplied to the guest user is set in step S24.

In step S25, the control commands having permission to execute are read from the feasibility table storage element 173 corresponding to the user I/D information. In the next step S26, the I/F information is generated in response to the retrieved control commands and the range of parameters and sent the generated I/F information to the PC 2 that originated the send request in step S21 (step S27).

According to the second modification of the present invention, the MFP 1 stores the execution feasibility table where the feasibility of executing each control commands of the multiple control commands is correlated with individual user ID information. When the acquisition request to get the I/F information is received (step S21), and the user ID information of the requesting user is acquired (steps S23 and S24), the executable control commands correlated with the user ID information are selected and read from the execution feasibility table (step S25), the I/F information is generated (step S26), and the generated information is sent (step S27). Because the control commands included in the I/F information have permission for execution granted based on the feasibility table stored in the feasibility table storage element 173, it is less likely to receive other control commands than the sent commands. This reduces the number of times the error procedure is executed (step S16), because the error procedure is run only when other control commands than sent commands are received (NO at step S12). This also contributes to security enhancement by preventing the receipt of the control commands other than the control commands having permission to execute.

Although the MFP 1 has been set forth in the above description of the embodiments according to the present invention, it is apparent to those skilled in the art that the I/F information disclosing procedures as shown in FIGS. 8, 12 and 14 may be implemented as a program or a method for disclosing the I/F information.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus, comprising:
an operation processing element capable of executing multiple types of operations;
an interface (I/F) information table storage element configured to store an I/F information table where each piece of I/F information of multiple pieces of the I/F information is correlated with one of multiple access levels, the each piece of the I/F information including control information to control the operation processing element;
an acquisition request receiving element configured to receive a request to acquire a piece of the I/F information;
a level acquiring element configured to acquire an access level of the acquisition request; and
an I/F information transmitting element configured to transmit the I/F information correlated with the acquired access level in the I/F information table.

2. An image processing apparatus according to claim 1, wherein
one of the multiple types of operations is defined for each control command of multiple control commands,
when one of the multiple control commands is received, the operation processing element executes a particular operation of the multiple types of operations identified by the received control command, and
each of the multiple pieces of the I/F information includes at least one control command of the multiple control commands.

3. An image processing apparatus according to claim 2, wherein
the I/F information includes a parameter corresponding to each control command of the multiple control commands,
when one of the multiple control commands is received together with the parameter corresponding to the received control command, the operation processing element executes a particular operation of the multiple types of operations identified by the received control command in accordance with the received parameter, and
each of the multiple pieces of the I/F information includes the parameter corresponding to the each control command of the multiple control commands.

4. An image processing apparatus according to claim 1, further comprising a definition table storage element configured to store a definition table where identification (ID) information for identifying a user or a device is correlated with one of the multiple access levels, and
the level acquiring element includes an ID information receiving element configured to receive the ID information, to acquire the access level correlated with the received ID information in accordance with the definition table.

5. An image processing apparatus according to claim 4, wherein
an access level of the multiple access levels correlated with the ID information of a predetermined particular user of a plurality of users is different from that correlated with the ID information of any user other than the particular user.

6. An image processing apparatus according to claim 1, further comprising an authentication element configured to authenticate a user, wherein
an access level of the multiple access levels correlated with the ID information of a user who is authenticated by the authentication element is different from that correlated with the ID information of any user who is not authenticated by the authentication element.

7. An image processing apparatus, comprising:
an operation processing element capable of executing multiple types of operations;
an acquisition request receiving element configured to receive a request to acquire interface (I/F) information including control information to control the operation processing element;
a level acquiring element configured to acquire an access level of the acquisition request;
an I/F information generating element configured to generate the I/F information in accordance with the acquired access level; and
an I/F information transmitting element configured to transmit the generated I/F information.

8. An image processing apparatus according to claim 7, wherein
one of the multiple types of operations is defined for each control command of multiple control commands,
when one of the multiple control commands is received, the operation processing element executes a particular operation of the multiple types of operations identified by the received control command, and
the apparatus further includes a selection table storage element configured to store a selection table where each access level of the multiple access levels is correlated with a condition for selecting at least one control command of the multiple control commands, wherein
the I/F information generating element generates the I/F information including the at least one control command selected from the multiple control commands in accordance with the condition correlated with the acquired access level in the selection table.

9. An image processing apparatus according to claim 8, wherein
when one of the multiple control commands is received together with the parameter corresponding to the one control command, the operation processing element executes a particular operation of the multiple types of operations identified by the received control command in accordance with the received parameter, and
the selection condition further includes a condition for selecting a range of parameters corresponding to each of the multiple control commands.

10. An image processing apparatus according to claim 7, further comprising a definition table storage element configured to store a definition table where ID information for identifying a user or a device is correlated with one of the multiple access levels, and
the level acquiring element includes an ID information receiving element configured to receive the ID information, to acquire the access level correlated with the received ID information in accordance with the definition table.

11. An image processing apparatus according to claim 10, wherein
an access level of the multiple access levels correlated with the ID information of a predetermined particular user of a plurality of users is different from that correlated with the ID information of any user other than the particular user.

12. An image processing apparatus according to claim 7, further comprising an authentication element configured to authenticate a user, wherein
an access level correlated with the ID information of a user who is authenticated by the authentication element is different from that correlated with the ID information of any user who is not authenticated by the authentication element.

13. An image processing apparatus, comprising:
an operation processing element configured to execute a particular operation in response to one control command of multiple control commands, when the one control command is received;
an execution feasibility table storage element configured to store an execution feasibility table where the feasibility of executing each control command of the multiple control commands is correlated with identification (ID) information which identifies a user or a device;
an authentication element configured to authenticate the user or the device by acquiring the ID information;
an interface (I/F) information generating element configured to generate the I/F information for the ID information acquired by the authentication element by choosing an executable control command correlated with the ID information in the execution feasibility table; and
an I/F information transmitting element configured to transmit the generated I/F information.

14. An image processing apparatus according to claim 13, wherein
when one of the multiple control commands is received together with a parameter corresponding to the one control command, the operation processing element executes a particular operation identified by the received control command in accordance with the received parameter,
the execution feasibility table storage element stores a range of parameters corresponding to each of the multiple control commands, and
the I/F information generating element includes a parameter selecting element to select a range of parameters corresponding to the selected control command.

15. An interface information disclosing program embodied in a computer readable recording medium and executed in an image processing apparatus capable of executing multiple types of operations, wherein
the image processing apparatus including an interface (I/F) information table storage element configured to store an I/F information table where each piece of I/F information of multiple pieces of the I/F information is correlated with each access level of multiple access levels, the each piece of the I/F information including control information to control the image processing apparatus,
the program comprising the steps of:
receiving an acquisition request to acquire one piece of the I/F information of the multiple pieces of the I/F information;
acquiring an access level of the acquisition request; and
transmitting the I/F information correlated with the acquired access level in the I/F information table.

16. An interface information disclosing program embodied in a computer readable recording medium according to claim 15, wherein
one of the multiple types of operations is defined for each control command of multiple control commands, the program further comprising a step of
executing a particular operation of the multiple types of operations identified by the received control command when one of the multiple control commands is received, wherein
the each piece of the I/F information of the multiple pieces of the I/F information includes at least one control command of the multiple control commands.

17. An interface information disclosing program embodied in a computer readable recording medium according to claim 16, wherein
the I/F information includes a parameter corresponding to each control command of the multiple control commands, the program further comprising a steps of
executing the operation of the multiple types of operations identified by the received control command in accordance with the received parameter when one of the multiple control commands is received together with a parameter corresponding to the one control command, wherein
the each piece of the I/F information includes the parameter corresponding to the each control command of the multiple control commands.

18. An interface information disclosing program embodied in a computer readable recording medium according to claim 15, wherein
the image processing apparatus further includes a definition table storage element configured to store a definition table where identification (ID) information for identifying a user or a device is correlated with one of the multiple access levels, and
the step of acquiring the access level further includes the steps of
receiving the ID information, and
acquiring the access level correlated with the received ID information in accordance with the definition table.

19. An interface information disclosing program embodied in a computer readable recording medium according to claim 18, wherein
an access level of the multiple access levels correlated with the ID information of a predetermined particular user of a plurality of predetermined users is different from that correlated with the ID information of any user other than the particular user.

20. An interface information disclosing program embodied in a computer readable recording medium according to claim 15, further comprising a step of
authenticating a user, wherein
an access level correlated with the ID information of a user who is authenticated in the authenticating step is different from that correlated with the ID information of any user who is not authenticated in the authenticating step.

21. An interface information disclosing program embodied in a computer readable recording medium executed in an image processing apparatus capable of executing multiple types of operations, the program comprising the steps of
receiving an acquisition request to acquire interface (I/F) information including control information to control the image processing apparatus;
acquiring an access level of the acquisition request;
generating the I/F information corresponding to the acquired access level; and
transmitting the generated I/F information.

22. An interface information disclosing program embodied in a computer readable recording medium according to claim 21, wherein
one of the multiple types of operations is defined for each control command of multiple control commands, the program further comprising a step of:
executing a particular operation of the multiple types of operations identified by the received control command when one of the multiple control commands is received, wherein
the image processing apparatus includes a selection table storage element configured to store a selection table where a selection conditions is correlated with each access level of multiple access levels to select at least one control command of the multiple control commands, and
the step of generating the I/F information includes a step of generating the I/F information including the at least one control command selected from the multiple control commands in accordance with the selection conditions correlated with the acquired access level in the selection table.

23. An interface information disclosing program embodied in a computer readable recording medium according to claim 22, further comprising a steps of:
executing a particular operation of the multiple types of operations identified by the received control command in accordance with the received parameter when one of the multiple control commands is received together with a parameter corresponding to the one control command, wherein
the selection conditions further includes conditions to select a range of parameters corresponding to each of the multiple control commands.

24. An interface information disclosing program embodied in a computer readable recording medium according to claim 21, wherein
the image processing apparatus further includes a definition table storage element configured to store a definition table where identification (ID) information for identifying a user or a device is correlated with one of the multiple access levels, and
the step of acquiring the access level includes the steps of
receiving the ID information, and
acquiring the access level correlated with the received ID information in accordance with the definition table.

25. An interface information disclosing program embodied in a computer readable recording medium according to claim 24, wherein
an access level of the multiple access levels correlated with the ID information of a predetermined particular user of a plurality of predetermined users is different from that correlated with the ID information of any user other than the particular user.

26. An interface information disclosing program embodied in a computer readable recording medium according to claim 21, further comprising a step of authenticating the user, wherein
an access level of the multiple access levels correlated with the ID information of a user who is authenticated in the authenticating step is different from that correlated with the ID information of any user who is not authenticated in the authenticating step.

27. An interface information disclosing program embodied in a computer readable recording medium and executed in an image processing apparatus capable of executing a particular operation in response to one control command of multiple control commands when the one control command is received, wherein
the image processing apparatus includes an execution feasibility table storage element configured to store an execution feasibility table where the feasibility of executing each control command of the multiple control commands is correlated with identification (ID) information which identifies a user or a device,
the program comprising the steps of:
authenticating the user or the device by acquiring the ID information;
generating interface (I/F) information for the ID information acquired in the authenticating step by choosing an executable control command correlated with the ID information in the execution feasibility table; and
transmitting the generated I/F information.

28. An interface information disclosing program embodied in a computer readable recording medium according to claim 27, further comprising a step of:
executing a particular operation identified by the received control command in accordance with the received parameter when one of the multiple control commands is received together with a parameter corresponding to the one control command, wherein
the operation feasibility table storage element stores a range of parameters corresponding to each of the multiple control commands, and
the step of generating the I/F information further includes a step of choosing a range of parameters corresponding to the selected control command.

29. An interface information disclosing method executed in an image processing apparatus capable of executing multiple types of operations, wherein
the image processing apparatus includes an interface (I/F) information table storage element configured to store an I/F information table where each piece of I/F information of multiple pieces of the I/F information is correlated with each access level of multiple access levels, the each piece of the I/F information includes control information to control the image processing apparatus,
the method comprising the steps of:
receiving an acquisition request to acquire one piece of the I/F information of the multiple pieces of the I/F information;
acquiring an access level of the acquisition request; and
transmitting the I/F information correlated with the acquired access level in the I/F information table.

30. An interface information disclosing method executed in an image processing apparatus capable of executing multiple types of operations, the method comprising the steps of:
receiving an acquisition request to acquire interface (I/F) information including control information to control the image processing apparatus;
acquiring an access level of the acquisition request;
generating the I/F information corresponding to the acquired access level; and
transmitting the generated I/F information.

31. An interface information disclosing method executed in an image processing apparatus capable of executing a particular operation in response to one control command of multiple control commands when the one control command is received, wherein
the image processing apparatus includes an execution feasibility table storage element configured to store an execution feasibility table where the feasibility of executing each control command of the multiple control commands is correlated with identification (ID) information which identifies a user or a device,
the method comprising the steps of:
authenticating the user or the device by acquiring the ID information;
generating the I/F information for the ID information acquired in the authenticating step by choosing an executable control command correlated with the ID information in the execution feasibility table; and
transmitting the generated I/F information.
